(19) United States
(12) Patent Application Publication
(10) Pub. No.: US 2020/0193391 A1
(43) Pub. Date: Jun. 18, 2020

(54) Automated Interval And Day-Of-Week Based Service Scheduling For Hotel/Rental Properties

(71) Applicant: CleanMeNext, LLC, Winter Park, FL (US)

(72) Inventors: Bill John Aspromonte, Winter Park, FL (US); Avram Seth Weiss, New York, NY (US)

(21) Appl. No.: 16/715,828

(22) Filed: Dec. 16, 2019

Related U.S. Application Data
(60) Provisional application No. 62/779,471, filed on Dec. 14, 2018.

(51) Int. Cl. G06Q 10/10; G06Q 30/06; G06Q 50/12

(52) U.S. Cl. CPC G06Q 10/1097; G06Q 50/12; G06Q 30/0645

(57) ABSTRACT

The invention relates to a system and method for automatically controlling service to be performed in various spaces in a facility allowing for the automatic scheduling and generation of service orders while allowing for dynamic adjustment to the type of service and time scheduled for the service to be performed. The system allows for increased accuracy of the type of service to be performed, it allows for dynamic changes to the service scope, while it also greatly increases the efficiency such that the service is completed in a more cost-effective manner.

### FIELD OF THE INVENTION

The invention relates to a system and method for automatically controlling services provided for a facility and more particularly to the generation of multiple different types of service orders for a space that are set according to a set service policy that is dynamically adjustable based on input received from various devices.

### BACKGROUND OF THE INVENTION

Many hotels now operate on non-daily periodic service programs to reduce personnel, operating, and materials expenses. A hotel can have several different programs, each offering different services, depending on the number of days a guest has stayed, or different days of the week.

Presently, the manual process of service scheduling requires the service assignment manager, usually the head housekeeper, to completely and accurately track and store information related to the number of days each guest has stayed over, and which services have been applied to which rooms on which days, and then apply that information to inform current-day service scheduling. Additionally, “real-time” changes to service levels due to a special guest request (e.g. “no service” or a modified service request) or incorrect assignment to staff that occur after the assignment manager has completed their work, will often preclude such changes from being properly accounted for and tracked by the assignment manager.

While there are systems that enable specification of a singular inter-day service schedule interval and service type, there are presently no hotel or rental property software-based service scheduling tools that enable fully-automated, fully-customized, multi-inter-day service scheduling and service type, and customizable service type indication, based on parametric stipulation of either number of days between servicing, or servicing for specific days of the week. Further, no existing systems track dynamic or real-time changes to service requests and apply them to user-selectable resolution actions.

The inability to accurately and completely track which days occupied rooms are to be serviced, along with what specific type of servicing those rooms are to receive, and what action to take should those rooms be inaccessible, can result in inefficient use of servicing resources and/or extra or no services performed. This in turn, results in significantly increased servicing expenses for hotel operators, or alternatively in a reduction in customer satisfaction scores.

### SUMMARY OF THE INVENTION

What is desired then is a system and method for automatically controlling multi-inter-day services provided for a facility that is capable of accurately and completely tracking which days occupied rooms are to be serviced and what specific type of service is to be performed.

It is further desired to provide a system and method for automatically controlling multi-inter-day services provided for a facility that dynamically accounts for changes to service levels due to a guest request.

It is still further desired to provide a system and method for automatically controlling multi-inter-day services provided for a facility based on either a number of days between servicing's, or servicing for specific days of the week

Finally, it is desired to provide a system and method for automatically controlling multi-inter-day services provided for a facility that tracks dynamic or real-time changes to service requests and applies them to user-selectable resolution actions.

These and other objects are achieved in one configuration with a method that enables fully-customizable parametric stipulation of multi-inter-day service schedules and types, enabling fully automated, fault-tolerant algorithmic scheduling of service dates and service types that combines the flexibility of variable-service interval with the precision of human-curated service scheduling. The method is fully coupled to real-time service type requests and requirements informed by both complete and accurate historical service records and guest requirements.

In one configuration a system provides the ability to parametrically stipulate, via automated or user-interface selection mechanisms, an automated per-room “service schedule”, either as frequency intervals, or on specific days of the week, along with the type of service to be provided during each servicing. The selected service schedule is then used in an algorithm to determine the date of the next service for that room. A room will only appear on staff mobile-display servicing lists when that date occurs, along with a customizable indicator denoting the service type the room is scheduled to receive.

It is contemplated that each service type may have a plurality of customizable parameters. For instance, the system may include two identity parameters that are the service type name and the icon used to represent the identity on displays. The system may also comprise two configuration parameters including, “allow slip” and “allow no service”, that provide for enhanced flexibility in accommodating real-time guest requests, while at the same time insuring that required servicing is not missed. If a configuration parameter is selected to “allow slip”, if a guest requests no service for their room for that day, that request is accommodated and scheduled for that day. However, the service that was scheduled for that day will automatically “slip” to be completed the following day or to another programmed day.

Upon completion of room servicing, the algorithm may then re-reference the policy schedule to automatically determine the next service date and service type. This ensures that the room will not appear on any servicing lists until the subsequent date.

To ensure that the algorithm produces consistently accurate results, it will be understood that several parameters must be correctly set in the system. However, these parameters may be subject to data-corruption and improper setting by users. In one configuration, the system can account for these types of faults by implementing fault-recovery techniques. In this way, any incorrect or missing values can be detected and correct or substitute parameters can be provided.

For this application the following terms and definitions shall apply:

The term “network” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

In one configuration a method for automatically controlling services provided for a facility with a computer coupled to a plurality of mobile devices is provided. The method comprises the steps of setting a service policy for a space in the facility, the service policy comprising a plurality of services to be performed for the space according to a time schedule and saving the selected service policy on the computer and providing a start date for the service policy and saving the start date on the computer. The method further comprises the steps of the computer generating a service schedule based on the selected service policy and the start date, the computer generating a first service order indicating a first type of service to be performed in the space on a first date and the computer transmitting the first service order to the plurality of mobile devices. The method still further comprises the steps of transmitting an indication from one of the plurality of mobile devices to the computer that the first service order has been completed and the computer generating a second service order indicating a second type of service to be performed in the space on a second date. The method is provided such that the first service can be the same type or a different type as the second service, and the first date is different than the second date. Finally, the method comprises the steps of the computer transmitting the second service order to the plurality of mobile devices and transmitting an indication from one of the plurality of mobile devices to the computer that the second service order has been completed.

In another configuration system for automatically controlling services provided for a room in a facility comprising a computer including a storage having at least one service policy saved thereon, the service policy comprising a plurality of services to be performed for the space according to a time schedule, an input module configured to receive a start date for the service policy, the start date saved on the storage and a scheduling module configured to generate a service schedule based on the service policy and the start date. The system is provided such that the scheduling module is configured to generate a first service order indicating a first type of service to be performed in the space at a first indicated time. The system further includes a plurality of mobile devices configured to receive the first service order. The system is further provided such that a first indication is transmitted from one of the plurality of mobile devices to said computer indicating completion of the first service order and the scheduling module is configured to generate a second service order indicating a second type of service to be performed in the space at a second indicated time where the first service can be the same type or a different type as the second service, and the first indicated time is different than the second indicated time. Finally, the system is provided such that a second indication is transmitted from one of the plurality of mobile devices to said computer indicating completion of the second service order.

Other objects of the invention and its particular features and advantages will become more apparent from consideration of the following drawings and accompanying detailed description.

### BRIEF DESCRIPTION OF THE DRAWINGS

FIG. 1 is a block diagram according to one configuration of the invention.

FIG. 2 is a block diagram according to the configuration of FIG. 1.

FIG. 3 is a block diagram according to the configuration of FIG. 1.

FIG. 4 is a functional block diagram according to the configuration of FIG. 1.

FIG. 4A is a flow diagram according to the functional block diagram of FIG. 4.

FIG. 5 is a functional block diagram according to the configuration of FIG. 1.

FIG. 6 is a screen depiction according to the configuration of FIG. 1.

FIG. 7 is a screen depiction according to the configuration of FIG. 1.

FIG. 8 is a flow diagram according to the configuration of FIG. 1.

FIG. 9 is a flow diagram according to the configuration of FIG. 8.

FIG. 10 is a flow diagram according to the configuration of FIG. 8.

FIG. 11 is a block diagram according to the configuration of FIG. 1.

FIG. 12 is a flow diagram according to the configuration of FIG. 11.

### DETAILED DESCRIPTION OF THE INVENTION

In the following description, for the purposes of explanation, numerous specific details are set forth in order to provide a thorough understanding of various embodiments disclosed herein. It will be apparent to one skilled in the art that various embodiments of the present disclosure may be practiced without some of these specific details. The following description provides exemplary embodiments and is not intended to limit the scope or applicability of the disclosure.

While the exemplary aspects, embodiments, and/or configurations illustrated herein may show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a node of a distributed network, such as an analog and/or digital telecommunications network, a packet-switch network, or a circuit-switched network. It will be appreciated from the following description that the components of the system can be arranged at any location within a distributed network of components without affecting the operation of the system.

Furthermore, it should be appreciated that the various links connecting the elements can be wired or wireless links, or any combination thereof, or any other known or later developed element(s) that can supply and/or communicate data to and from the connected elements.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In another configuration, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the function and the software or hardware systems or microprocessor or microcomputer systems being utilized.

In still another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer, as a resource residing on a server or computer workstation, or the like.

Various additional details of configurations will be described below with reference to the figures.

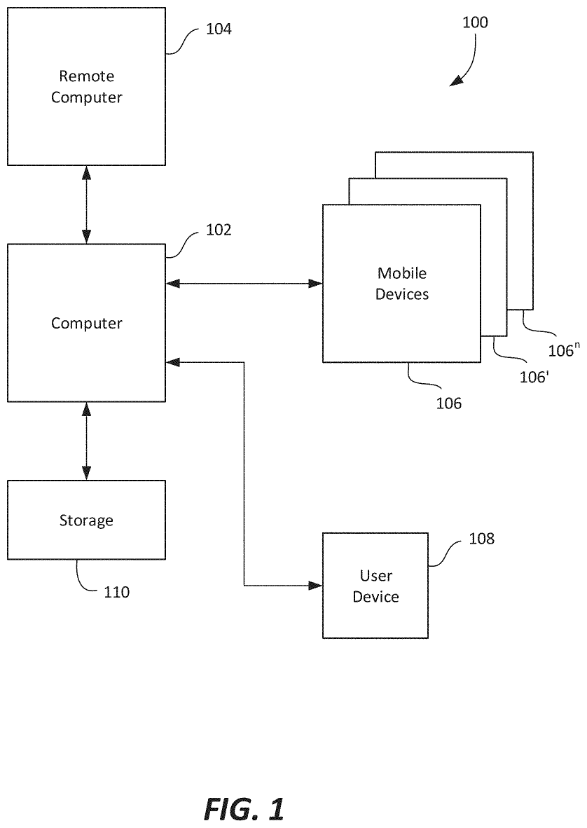

FIG. 1 is a block diagram illustrating elements of an exemplary computing environment in which various configurations may be implemented. More specifically, FIG. 1 illustrates a computing system 100 that may function as the servers, user computers, or other systems provided and described herein. The system 100 includes one or more computing devices, such as a computer 102, a remote computer 104, a plurality of mobile devices 106, 106′, 106ⁿ, and/or user device 108.

The computer 102 is provided with a storage 110 that is accessible by computer 102. Storage 110 is provided for storing various data to be used by computer 102 and may further be accessible by remote computer 104 and the plurality of mobile devices 106, 106′, 106ⁿ, and/or user device 108. Storage 110 may comprise an internal or external device. Remote computer 104 is shown coupled to computer 102, which connection may comprise a network connection. Additionally, the plurality of mobile devices 106, 106′, 106ⁿ, which connection is contemplated to comprise a wireless connection. In one configuration, the plurality of mobile devices 106, 106′, 106ⁿ may connect to Wi-Fi for the facility.

User device 108 is contemplated to be a mobile device located in the room that is to be serviced and is wirelessly connected to computer 102. The user device may comprise virtually any type of mobile device that may be connected via, for example, Wi-Fi and comprises a tablet or the like.

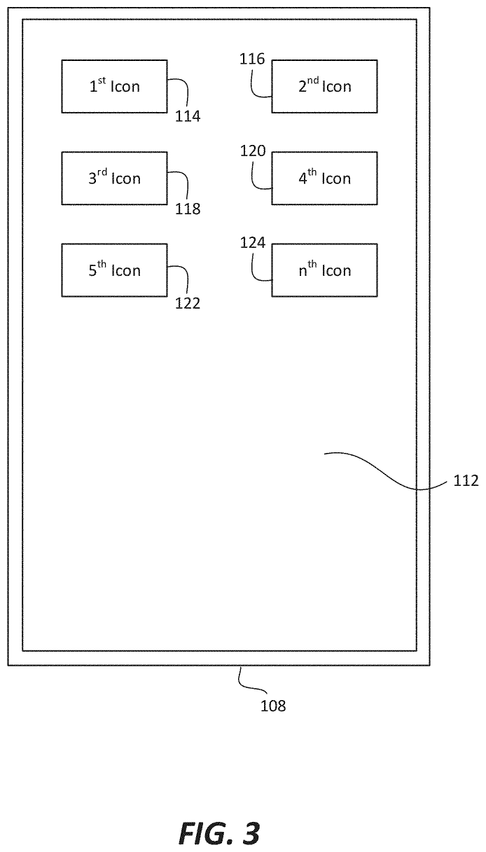

User device 108 can be seen in connection with FIG. 3, which illustrates the device and can include a screen 112, which may comprise a touch screen, that may present various icons 114, 116, 118, 120, 122, 124 to the user. These icons can illustrative of the type of service to be performed in the room. For example, the user may have checked into a hotel room for a period of five days. During that time period, various services in the form of service orders may be scheduled including, for example, a light cleaning(s), regular cleaning, a heavy cleaning, special cleaning, maintenance, etc. These various types of service orders may be diagrammatically depicted via icons on the screen 112 of user device 108. While the “icons” depicted in FIG. 3 are generic, it is contemplated that they can be provided to convey the type of service requested. For example, icon 114 may correspond to a light cleaning and could be depicted as a service personnel with a feather duster; icon 116 may correspond to a regular cleaning and could be depicted as a service personnel with a vacuum cleaner; icon 118 may comprise a heavy cleaning and could be depicted as a service personnel scrubbing on their hands and knees. Additionally, icon 120 may correspond to a request to change the linens and could be depicted as a service personnel flipping a sheet onto a bed; icon 122 may comprise a repair request and could be depicted as a wrench (and would require additional information to be entered by the user relating to the specific repair request); and icon 124 could be a request for some type of special service, which would also require the user to enter additional information relating to the request. It should be noted that icon 124 is labeled as nth icon indicating that while six icons are shown on user device 108, virtually any number of icons can be programmed and provided.

Additionally, it is contemplated that when a service is scheduled to be performed in a room on a particular day as a service order, the service order may be sent to the user device 108 as a notification and may include an audible signal alerting the user that a specific service has been scheduled for the day. In one configuration, the user device 108 may prompt the user to confirm the scheduled service. Alternatively, the user device 108 may allow the user to select a different service to be performed that day including a selection of “no service” for that day. Any modification of the scheduled service can be sent from the user device 108 to the computer 102 allowing rescheduling of the service for that day (and potentially a change to following services scheduled for later in the week). The user device 108 may allow the user to make note of specific things the user would like, such as, changing of the towels, extra towels or toiletries be stocked in the room, additional blankets, and so on. All this allows for increased dynamic feedback and instructions from the user to reach management and the individuals that are potentially servicing the rooms. The automated nature of the system reduces human error and allows for real-time or near real-time updating of service personnel mobile devices 106, 106′, 106ⁿ, which allow the service personnel to stock their carts with any requested special items (e.g., extra blankets) they may not normally take for routine cleaning. Additionally, the real-time nature of updates to the system ensures that changes that may be input to the system are dynamically updated to the mobile devices such that service personnel that may be already working in the vicinity of a room service order receive the most up-to-date instructions for each particular service order. For example, a guest may request a particular service be applied to their room via the user device in the room, and then leave. A few minutes later service personnel come into the room to perform the service order. The service order will have already been updated with the change or special service request from the guest ensuring that the room receives the proper service due to the real-time nature of updates.

When the user device 108 is a mobile device, it may include a charging station in which the device is placed when not in use. Alternatively, the user device 108 may comprise a wall-mounted device that a user can access as a touch screen and could be hard-wired. Either configuration or another configuration can allow for the specific feature and benefits described above.

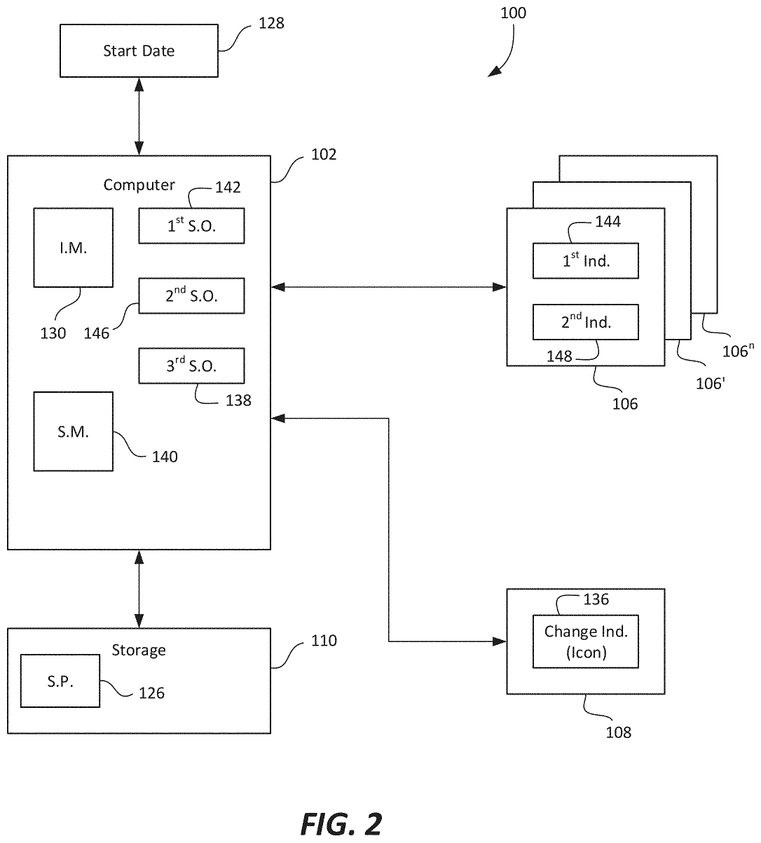

Turning now to FIG. 2, a block diagram is provided that presents more detail of functioning and interaction between computer 102 and the plurality of mobile devices 106, 106′, 106ⁿ. In this configuration, computer 102 is depicted including input module 130 and scheduling module 140, both of which may comprise software executing on computer 102. Storage 110 includes a service policy 126 stored thereon that includes a rule set or algorithm establishing various services to be performed in a room at certain times. Once a service policy is established for a room, a start date 128 must be input into input module 130. It will be understood that while the term “start date” is used, this term also includes data relating to the duration of the stay. Based on the service policy, the beginning date for the service policy to go into effect and the duration of the service policy (the length of stay), the scheduling module 140 will generate a service schedule. In one configuration, the service schedule may include multiple services that are to be performed in the room and the days on which those services are to be performed. In another configuration, the service schedule may include only the next service and service date according to the service policy. Ideally, the service(s) in the service schedule will not be viewable by the plurality of mobile devices 106, 106′, 106ⁿ unless a service order is generated to be performed that day. It should be understood that various services may be scheduled depending on the duration of the guest stay in the room. For example, for a relatively short stay (e.g. five days), the system may only schedule a light cleaning and a regular cleaning. However, for an extended stay (more than 10 days), the system may include various services such as a heavy cleaning, or multiple full cleanings. This will be determined by the information provided relating to the service policy for the room, the check-in date and the scheduled check-out date. The scheduling module 140 will automatically build the service schedule based on all of the inputted data.

As shown in FIG. 2, the scheduling module may generate first service order 142, which will be sent to one or more of the plurality of mobile devices 106, 106′, 106ⁿ, for example in the morning on the day the service order is to be performed. Additionally, the first service order 142 may be sent to user device 108 as a notification to the user. Service personnel will work through the various service orders that have been transmitted to their mobile device and once a particular service order has been completed (e.g., service personnel completes a light cleaning of the room), the service personnel that performed the service can send a first indication 144 that first service order 142 is complete. This will function to complete first service order 142 on computer 102 such that scheduling module 140 will remove first service order 142 from the plurality of mobile devices 106, 106′, 106ⁿ. Each of the plurality of mobile devices 106, 106′, 106ⁿ are assigned to individual service personnel. As such, a first indication 144 that first service order 142 has been completed received by mobile device 106 will function to credit the service personnel associated with mobile device 106 for completing service order 142.

Also shown on FIG. 2 is change indication 132, which can be input into user device 108 and function to modify first service order 142 as previously described. For example, the user may be in their hotel room and decide that “no cleaning” is needed and may select that option on the user device 108. This will be transmitted from the user device 108 to computer 102 via input module 130 and then provided to scheduling module 140. Scheduling model 140 can, in turn, then cancel first service order 142 deleting is from all of the plurality of mobile devices 106, 106′, 106ⁿ.

Assuming that the first indication 144 was received by computer 102 via input module 130, the scheduling module can then generate second service order 146, which may comprise the same type of service as prescribed in the first service order or may comprise a different type of service. For example, the first service order 142 may comprise a light cleaning of the of the room and the second service order 146 may also comprise a light cleaning, albeit to be performed on a different day than the first service order. Alternatively, the second service order 146 could comprise a regular cleaning or a heavy cleaning, etc. The second service order 146 is transmitted out to the plurality of mobile devices 106, 106′, 106ⁿ, when the service is to be completed, as described in connection with the first service order 142. Once the service is done, a second indication 148 may be transmitted from one of the plurality of mobile devices 106, 106′, 106ⁿ to the computer 102 indicating the second service order 146 is completed. This information is provided to scheduling module 140, which then removes the second service order 146 from the plurality of mobile devices 106, 106′, 106ⁿ.

In another configuration, the user device 108 could transmit a request to computer 102. This request could be a change indication 136 that requests that a scheduled service be modified in some way or even canceled; or the request could be a special request asking for an unscheduled service as previously described. In the case of an unscheduled service, third service order 138 is depicted in FIG. 2, which can be generated by the schedule module and transmitted to the plurality of mobile devices 106, 106′, 106ⁿ to be completed as previously described in connection with the first service order 142 and the second service order 146.

In still another configuration, it is contemplated that the plurality of mobile devices 106, 106′, 106ⁿ may be trackable in the facility (e.g., which floors are the mobile devices located and where on the floor). This would allow the system to identify which mobile devices and associated service personnel may be the closest to a particular service order location, such that the system can assign service orders to service personnel based on proximity. For example, if a total of 35 service orders have been sent out to 7 different mobile devices in a multi-story hotel, the system could track the location of the 7 different mobile devices and individually highlight on each mobile device which of the 35 service orders are the closest (e.g. on the same floor or even within a set geographical range) to that mobile device. The identified service orders could be “highlighted” on the screen of the mobile device, which could include changing the color of the service order (i.e., shown in green) or could include surrounding the service order icon on the screen in a colored border, or any other visual indication of which service orders should be next. It is contemplated that the system could dynamically or periodically update the location of the various mobile devices and correspondingly update the currently pending service orders that are in the vicinity of the particular mobile device.

Still further, the system could also indicate if there is a critical service order that needs immediate attention and could highlight this on the screen of the nearest service personnel. For example, a guest may want an early check-in so the system determines the service personnel closest to the room and indicates an urgent request to perform the service order. In one configuration, the system may request a reply from the service personnel that the urgent service order will be initiated immediately, and if the service personnel indicates that the indicated urgent service order cannot be performed in the prescribed time frame, the system could then locate the next closet service personnel and so on.

In any event, the system would therefore allow for a more accurate and efficient mechanism for servicing the rooms by matching the closest service personnel with the closet service order. Likewise, the system would allow for a more accurate and efficient way to effect urgent service orders that may be generated by management or even by an existing guest utilizing the user device 108.

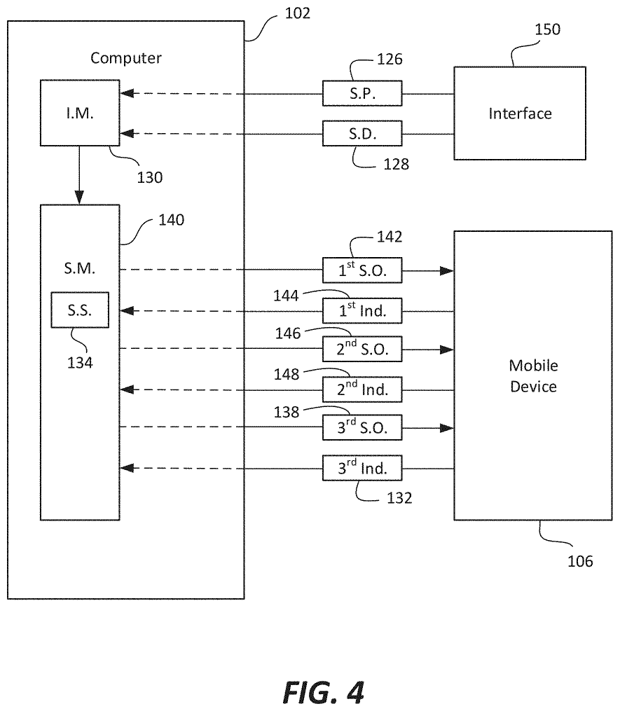

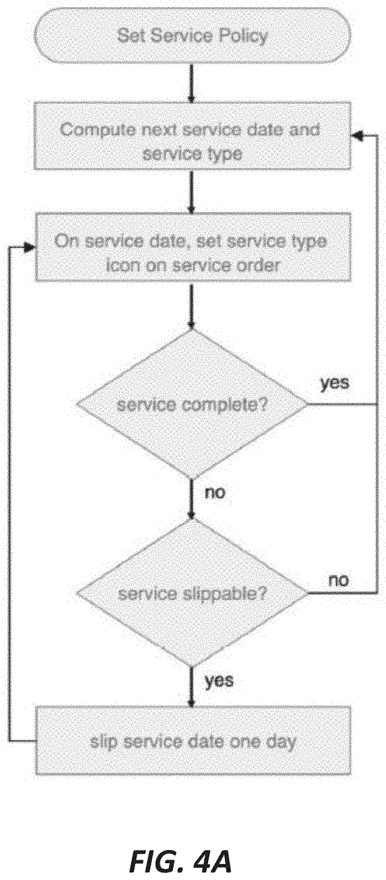

Referring now to FIG. 4, a functional block diagram is provided illustrating the various data that is transmitted and exchanged in the system 100. For example, service policy 126 may, in one configuration, be provided to input module 130. Service policy 126 could be a selection that is made by an administrator from a plurality of service policies (not shown) or may be provided directly by the administrator or may be a default setting of the system. An interface 150 is provided for providing an interface to computer 102 allowing the administrator to set the service policy 126. Also shown is start date 128 being provided by interface 150. As previously stated, this data may comprise information relating to when the user begins occupying the room and thereby is indicative of when the servicing schedule should begin. The start date 128 may further include information relating to the duration of the stay, which will impact the service schedule that is generated.

Once the input module has received all this data, the information is provided to scheduling module 140, which may generate a service schedule 134. The term “service schedule” may encompass a number of different forms or data structures. For example, the service schedule could comprise a full schedule of services types and dates that are generated by the system upon input of the start date and stay duration in connection with the service policy. Alternatively, the service schedule could comprise a system where the system only generates one service order (having a service type and date) at a time to be transmitted on the appropriate date to the mobile devices. In one configuration, the scheduling module 140 may reference various schedules or service policies during algorithmic determination of a next service. The determination can be based in part on certain events that occur during the normal room occupancy cycle. These events can include, for example, guest check-in and service completion, or on-demand guest service requests such as no service and service re-schedule. After the scheduling module 140 calculates the next service date and type based on the start or base date and the service policy, the scheduling module 140 then calculates and saves both values to use during the next service-listing cycle which corresponds to the date the next service order is to be generated and transmitted.

The service schedule 134, in a broad sense comprises data that is used by the system in conjunction with the data comprising the service policy, to facilitate generation of service orders defining the type of service that will be performed and when that service should be completed. For example, when the calendar date corresponds to the computed next service date, the scheduling module 140 places the room on the daily service required list, which is transmitted to servicing personnel. Upon completion of a servicing, the scheduling module 140 includes an algorithm that references the stated room service schedule data declaration to again compute the next service date and type. In one example, if the occupant is staying in the room for six days, the service schedule could provide for a light cleaning on the second and fourth days, and a heavy cleaning on the sixth day. In another configuration, the system could schedule cleaning based on the day of the week (e.g., user checks in on a Sunday, light cleaning is scheduled for Monday and Wednesday, and heavy cleaning is scheduled for Friday) based on recurring renting patterns. This type of scheduling is particularly helpful for part-time workers that may only work at the facility on certain days of the week (e.g., Monday, Wednesday, Friday). Still further, a hybrid between the two different types of service schedules could be adopted as desired.

In any event, the scheduling module 140 enables parametric stipulation via a service policy of one or more room service schedules and associated service types for an occupied room. As described above, there are typically two general models available to create a service policy: a day-count-interval format, and a day-of-week format.

In the interval-based format, the frequency of a service type is stated in days from a “base date”, where the “base date” is preferably initially the check-in date. The “base date” may be changed to alter the schedule. For example, if a scheduled service is moved one day forward, the base date can be moved one day forward to effect the schedule change, or if the service policy is changed to a different policy, the base date can be changed to the date of the policy change. In the day-of-week-based format, a specific day of the week is assigned a specific service type. In one configuration, JavaScript Object Notation (JSON) structures may effectively be used to capture and express both formats.

A JSON data structure is an ASCII character-based representation of a logical grouping of key-value pairs. Such groupings are often created based on and/or to represent the associative nature of the elements in the structure. For example the following JSON structure could be used to provide a mapping between days of the week and their numeric value being used in a particular application: {“mon”: “1”, “tues”:“2”, “wed”:“3”, “thu”:“4”, “fri”:“5”, “sat”:“6”, “sun”:“7”}.

JSON may be used in the system 100 to provide a generalized, flexible, extensible, logical grouping of all the service types to be provided in a particular service policy, as well as to indicate the specific service interval for each service type included in the policy.

Turning back to FIG. 4, the scheduling module 140 can generate a service schedule 134 and the scheduling module generates first service order 142 based on the service schedule 134 and/or the service policy 126, and as the first service order comes due (i.e., on the day that it is due), it is transmitted to the plurality of mobile devices 106, 106′, 106ⁿ. Once the first service order 142 is completed, a first indication 144 may be transmitted from the mobile device 106 associated with the service personnel that completed the first service order 142 to computer 102.

Additionally, upon receipt of the first indication 144, the service schedule 134, scheduling module 140 generates second service order 146 based on the service schedule 134 and/or the service policy 126, and as the next service for the room comes due, the second service order 146 is transmitted to the plurality of mobile devices 106, 106′, 106ⁿ. Once the second service order 146 is completed, a second indication 148 may be transmitted from the mobile device 106 associated with the service personnel that completed the second service order 146 to computer 102.

Referring now to FIG. 4A, a flow diagram is provided to further explain implementations of scheduling module 140 and the generation of the various service orders. As can be seen, in FIG. 4A, the service policy is set and in conjunction with the base or start date, the system will compute and store the next service date and type. When the date for that service comes up, the system will transmit the service order to the mobile devices by generating a visible service icon on the displayed service order that shows up on the mobile devices. The system will then determine if the service was completed and if not, determine if the service policy allows for slip and if so, it will slip the service order.

In discussing the conceptual flow diagram of FIG. 4A with the specifics of the system discussing in connection with FIG. 4, in one configuration, if the first service order 142 is not done or if a negative indication is received that the first service order 142 will not be done, the system can react in several different ways. In one configuration, if the service policy or service type allows for it, the system will slip the first service order 142 to the next day. Such a slip can be accomplished by adjusting the start date of the service policy forward by one day. This in turn, would slip the second service order 146 by one day and so on for each service order generated in turn by the system based on the service policy. However, if the service policy or service type does not allow for slip, the system can then proceed to schedule (e.g., compute and store) the second service order 146 to be sent out on the proper date based on the service policy. The system can reference predetermined settings for each service to determine if a service type allows for slip.

In determining a termination of a service order (whether completed or not completed), if a completion indication is received or a negative (will not be completed) indication is received on the service date (i.e., during the day when the service is scheduled), the scheduling module 140 can then immediately schedule (e.g., compute and store) the second service order 146. If no indication is received during the service date, the scheduling module 140 can wait till the end of the day (e.g., on or around midnight or another predetermined time) and then either slip the associated service, if a slip is permissible as described above, or schedule the next service order, e.g., second service order 146.

A third service order 138 is shown in FIG. 4 and may comprise either a further scheduled service order based on the user's duration of stay in the room or may comprise a special service order or a change order. In any event, the system functions as described above with the third service order 138 being transmitted to the plurality of mobile devices 106, 106′, 106ⁿ. Once the third service order 138 is completed, a third indication 132 may be transmitted from the mobile device 106 associated with the service personnel that completed the third service order 138 to computer 102.

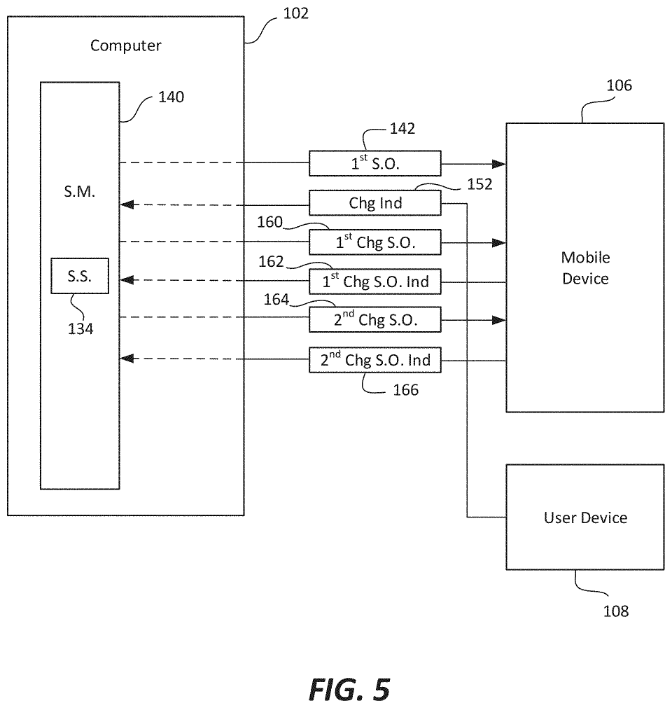

FIG. 5 is a functional block diagram that illustrates the various data that is transmitted and exchanged in the system 100 when a change to a scheduled service is input into the system. In this configuration, once the scheduling module 140 generates the first service order 142 based on the service schedule 134 and transmitted to the plurality of mobile devices 106, 106′, 106ⁿ, before the first service order 142 can be completed, the user device 108 generates and transmits a change indication 152 to computer 102. The change indication 152 can comprise any type of change to the first service order 142. For example, the change indication 152 could be a request to not perform the scheduled service for that day, or it could be a request to modify the scheduled service for that day, or it could be a request to perform an additional service beyond the scheduled service for that day. In any event, the change indication 152 is received by scheduling module 140, which in turn, modifies the first service order 142 (including deletion thereof). Based on the received information, scheduling module 140 then generates and transmits first change service order 160. The process of generating and transmitting the first change service order 160 may include automatic deletion of first service order 142, or the process could comprise automatically overwriting first service order 142. In either case, the first service order 142 is no longer presented on the plurality of mobile devices 106, 106′, 106ⁿ, but is now replaced by the first change service order 160. The service personnel that perform the service associated with the first change service order 160 can then submit a first change service order indication 162 that the service has been completed.

The scheduling module 140, depending on the type of change presented in the change indication 152, may then generate second change service order 164. The second change service order 164 may function to automatically delete or overwrite the second service order 146. It is contemplated that the second change service order 164 may comprise identical service to be performed as the second service order 146, however, it may be indicated to be performed on a different day. Alternatively, the second change service order 164 may comprise a different type of service to be performed altogether.

The second change service order 164 is transmitted to the plurality of mobile devices 106, 106′, 106ⁿ. The service personnel that perform the service associated with the second change service order 164 can then submit a second change service order indication 166 that the service has been completed.

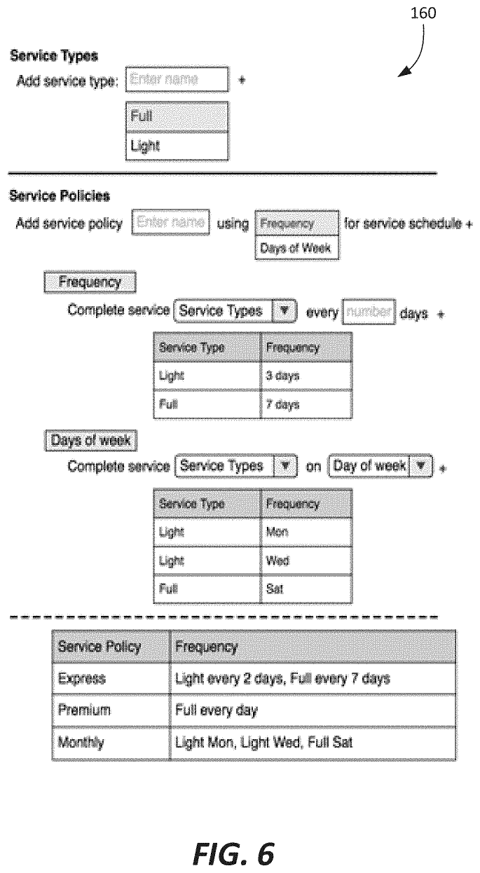

To ensure service policy structures are well-formed JSON structures, a service type and policy “builder” has been created. The builder user interface shown in FIG. 6 enables creating custom service types, and custom service policy schedules based on either interval or day-of-week based stipulation.

In one configuration, the interface 160 for selection of the service policy shows that a “light” service type is completed every second (i.e. other) day starting from the aforementioned “base date” (e.g. guest check-in), and a “full” service is completed every sixth day (i.e. every third service). In the day-of-week schedule format, the entry indicates that a “light” service type is to be completed every Monday and Wednesday, and a “full” service type every Saturday.

Accordingly, when looking at the JSON structures, in an interval-based schedule it would comprise: {“2”:“light”, “6”:“full”} whereas in a day-of-week-based schedule it would comprise: {“mon”:“light”, “wed”:“light”, “sat”:“full”}.

The scheduling module 140 references the parametric service schedules during algorithmic determination of the next service based on “events” that occur during the normal room occupancy cycle, such as “occupant check-in” and “service completion”, as well as on-demand guest service requests such as “no service” and “service re-schedule”. After it computes “next service” date and type, the scheduling module 140 calculates and saves both values to use during the next service-listing cycle.

When the calendar date is the same as the computed ‘next service” date, the scheduling module 140 places the room on the daily “service required” list, to be assigned to servicing personnel and transmitted out to the plurality of mobile devices 106, 106’, 106ⁿ. Upon completion of a servicing, the scheduling module algorithm references the stated room “service schedule” data declaration to compute the “next service” date and type.

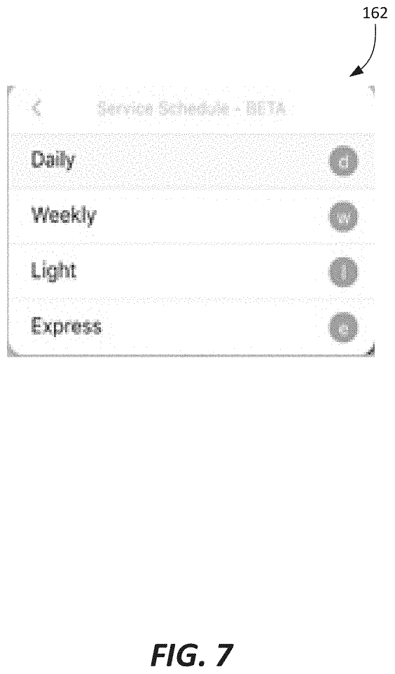

Each hotel/property may include a “property-wide default” service schedule that is automatically applied to a room during the “occupant check in” event. Each room can have a “per room” default service schedule that takes precedent over the “property-wide default” if required. Finally, the schedule can be switched manually via the schedule selection menu 162 shown, for example, in FIG. 7.

Certain events, such as a no service event, or a manual schedule change event, will result in the scheduling module 140 dynamically adjusting the base date for interval-based schedules to adjust for slippages in scheduled cleaning, depending on if the specified service type allows for service date slippage as previously discussed.

To illustrate, a “check-in” event for a room occurs on 2019 Jun. 1. Using an interval-based schedule where a “base date” of 2019 Jun. 1 is set, the next generated service order will list a “light” service type on 2019 Jun. 3.

However, if on 2019 Jun. 3, the room has a “no service” event occur and if the “light” service type allows for slippage, service will be deferred to the next day, 2019 Jun. 4, and the “base date” will be advanced one day to 2019 Jun. 2 to accommodate the one-day slip. If the deferred service is completed on 2019 Jun. 4, the next service set will be another “light” service on 2019 Jun. 6. If the “light” service type does not allow for slippage, then the next service type and date will be computed; another “light” service on 2019 Jun. 5.

Rooms using day-of-week schedule are based on a “named day” scheduling, and a service type set for a specific day of the week will be scheduled to repeat each week on that specific day, though the actual day of completion is subject to whether the scheduled service type supports slipping. For example, a room using the day-of-week service policy format may be scheduled to receive a “light” cleaning on Monday and Wednesday, with a full cleaning Saturday. If a “no service” event occurs on Monday, and the “light” service type allows for a slip, servicing will be attempted Tuesday. If servicing is completed on Tuesday, the next scheduled service order will be a “light” service on Wednesday. If the service scheduled for Monday does not support slipping, then the next service order will be a “light” service on Wednesday.

It should be noted that in one configuration, a room will only appear on servicing personnel mobile devices when the “next service” date occurs. The room listing may include customer-selected iconography (e.g., a graphical representation) presented on a display of the mobile device to depict the service type the room is scheduled to receive. While virtually any type of graphic could be used, in one configuration a “half-full thermometer” could indicate that a “light cleaning” is scheduled whereas a “full thermometer” could indicate that a “full cleaning” is scheduled. Again, it is contemplated that various icons could be used to graphically convey to the customer and the service personnel what type of service is scheduled to being requested. Customers can select a unique icon representation for each service type specified.

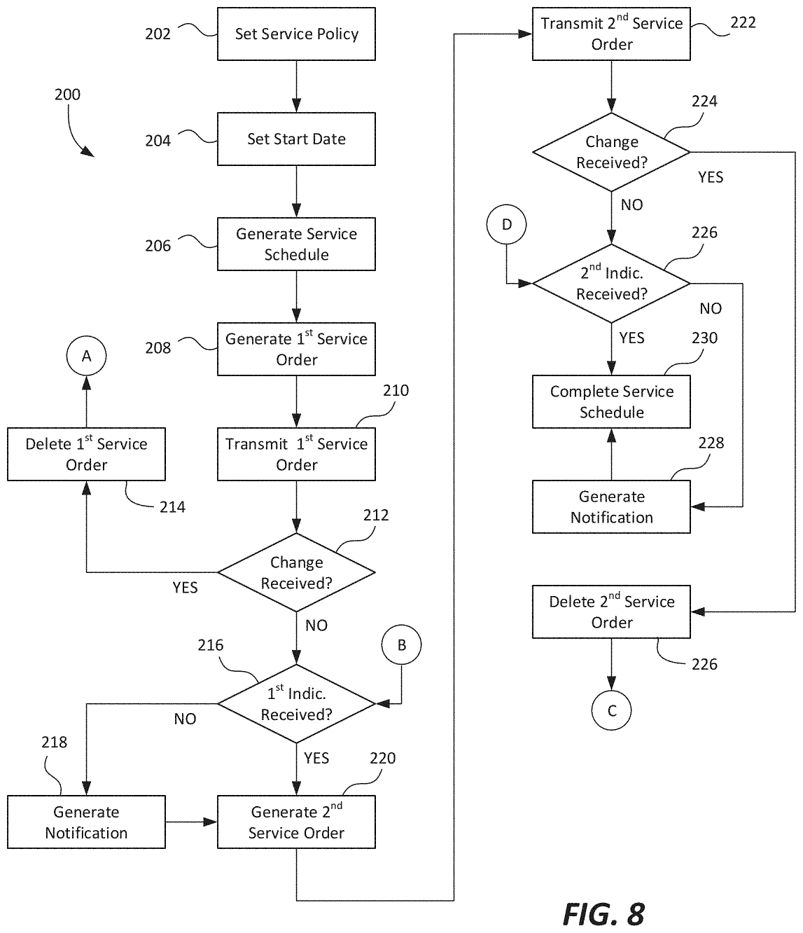

While the following flowcharts will be discussed and illustrated in relation to a sequence of events, it should be appreciated that changes, additions, and omissions to this sequence can occur without materially affecting the operation of the disclosed configurations. FIGS. 8-10 depict functional flow charts illustrating various steps and processes that may be performed by the system 100 described in conjunction with the previously described FIGS. 1-7.

A process 200 for automatically controlling services provided for a facility is provided at FIG. 8. Initially, a service policy is set 202 and a start date (base date) is set 204. From that point the process proceeds to generate and store a service schedule 206 for the room. Once the first service date is reached, the system then generates a first service order 208. The first service order 208 is transmitted 210 to a plurality of mobile devices that are associated with various service personnel in the facility. As stated previously, the mobile devices could comprise tablets or the like that provide information to cleaning and maintenance personnel relating to various rooms in a hotel. The system monitors to see if a change indication has been received 212. If so, the system then deletes the first service order 214 so that it no longer appears on the mobile devices that are associated with various service personnel in the facility. If a change indication has not been received, the system then determines if a first indication has been received 216. The first indication would comprise data transmitted from one of the plurality of mobile devices that indicates that the service associated with the first service order has been completed. This monitoring will, in one configuration, extend for the day in which the service order is to be completed. If no indication has been received within the time frame, the system will generate a notification 218 that the first service order has not be completed. This notification can be presented on the computer 102 or be transmitted to remote computer 104 or be transmitted as an email, text message, instant message or any other suitable means that could be accessed by management of the hotel. If the first indication has been received, thereby indicating the service associated with the first service order has been completed, the system moves to generate a second service order 220, which would occur on the date specified by the service schedule. The system will then transmit the second service order 222 to the plurality of mobile devices that are associated with various service personnel in the facility.

The system will continue to monitor to see if a change indication has been received 224. If so, the system then deletes the second service order 226 so that it no longer appears on the mobile devices that are associated with various service personnel in the facility. If a change indication has not been received, the system then determines if a second indication has been received 226. If no indication has been received within the time frame, the system will generate a second service order notification 228 that the second service order has not be completed. This second service order notification can be transmitted as previously discussed in connection with the first service order notification. If the second indication has been received, the system in this configuration moves to complete service schedule 230. The complete service schedule could automatically include the scheduling of an additional service order (e.g., schedule a full cleaning of the room in preparation of renting it to another guest), and could further include scheduling of maintenance items, repairs and so on automatically blocking the re-renting of the room until those outstanding items are completed.

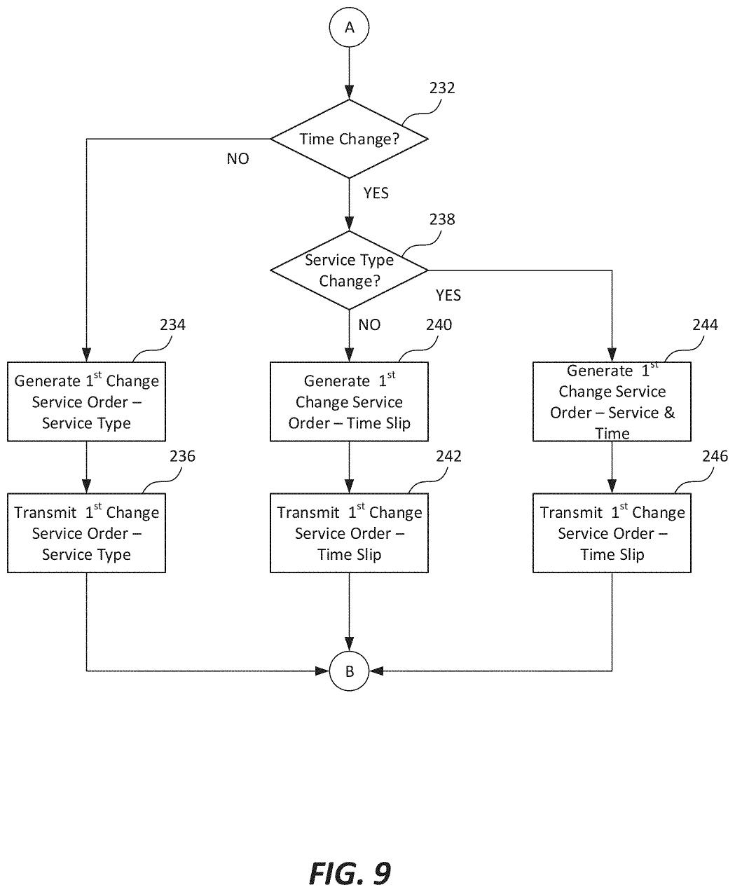

Turning now to FIG. 9, the “A” symbol on FIG. 8 indicates that after the system then deletes the first service order 214, the system moves to determining if a time change is requested 232 for the first service order. For example, the first service order could be a scheduled light cleaning of the room, however, the user or guest determines that a light cleaning is not needed that day. Depending on the service schedule, the system could attempt to reschedule the light cleaning for the next day. In this event, a time change for the light cleaning is initiated. If it is determined that no time change is indicated, for example, the change received relates to the type of service to be performed (not the date on which it is to be performed), the system moves to generate first change service order service type 234. This would be a modified service order that would factor in the change indication. From there the system would transmit the first change service order service type 236 to the plurality of mobile devices, after which the system would proceed to “B” connecting back to FIG. 8.

If a time change was indicated in the change indication, the system would move to determining if a service type change was also indicated 238. If no service type change was provided, the system would then advance to generate first change service order time slip 240 providing for the service associated with the first service order to be performed at a different time/date. From there the system would transmit the first change service order time slip 242 to the plurality of mobile devices, after which the system would proceed to “B” connecting back to FIG. 8.

If both a time change and a service type was indicated in the change indication, the system would advance to generate a first change service order service type and time slip 244 providing for both a different scope of service and a different time or date for the service compared to the first service order. From there the system would transmit the first change service order service type and time slip 246 to the plurality of mobile devices, after which the system would proceed to “B” connecting back to FIG. 8.

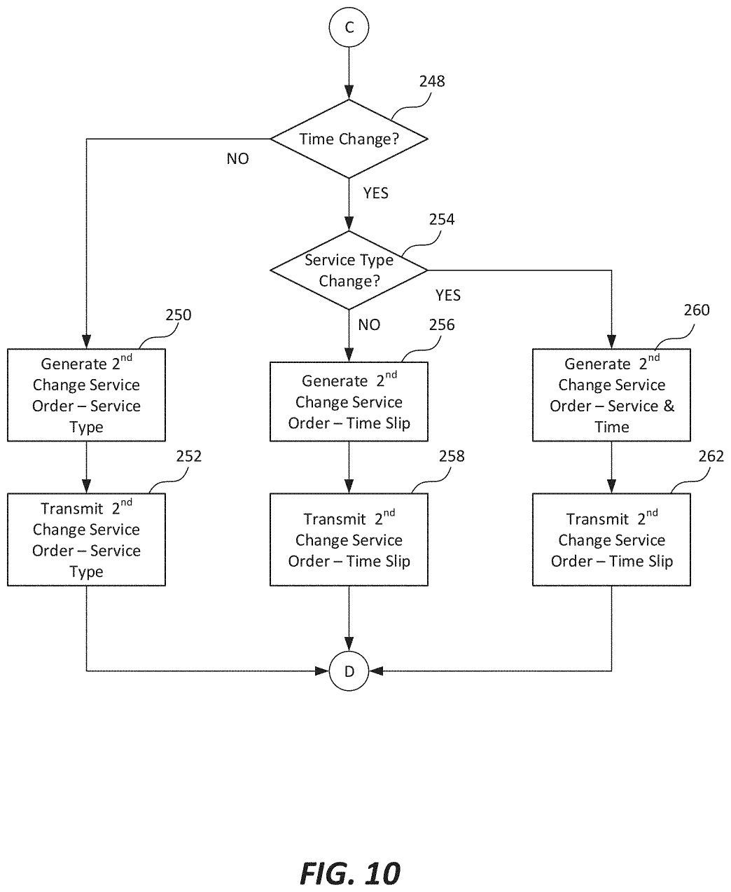

Turning now to FIG. 10, the following function in a similar way as described in connection with FIG. 9 except for the change indication relating to the second service order. The “C” symbol on FIG. 8 indicates that after the system then deletes the second service order 226, the system moves to determining if a time change is requested 248 for the second service order. If it is determined that no time change is indicated, the system moves to generate second change service order service type 250. From there the system would transmit the second change service order service type 252 to the plurality of mobile devices, after which the system would proceed to “D” connecting back to FIG. 8.

If a time change was indicated in the change indication, the system would move to determining if a service type change was also indicated 254. If no service type change was provided, the system would then advance to generate second change service order time slip 256 providing for the service associated with the second service order to be performed at a different time/date. From there the system would transmit the second change service order time slip 258 to the plurality of mobile devices, after which the system would proceed to “D” connecting back to FIG. 8.

If both a time change and a service type was indicated in the change indication, the system would advance to generate a second change service order service type and time slip 260 providing for both a different scope of service and a different time or date for the service compared to the second service order. From there the system would transmit the second change service order service type and time slip 262 to the plurality of mobile devices, after which the system would proceed to “D” connecting back to FIG. 8.

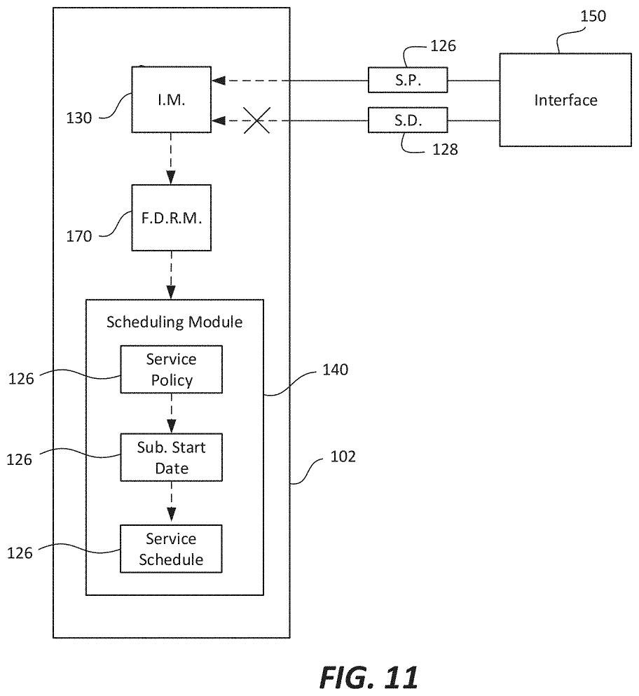

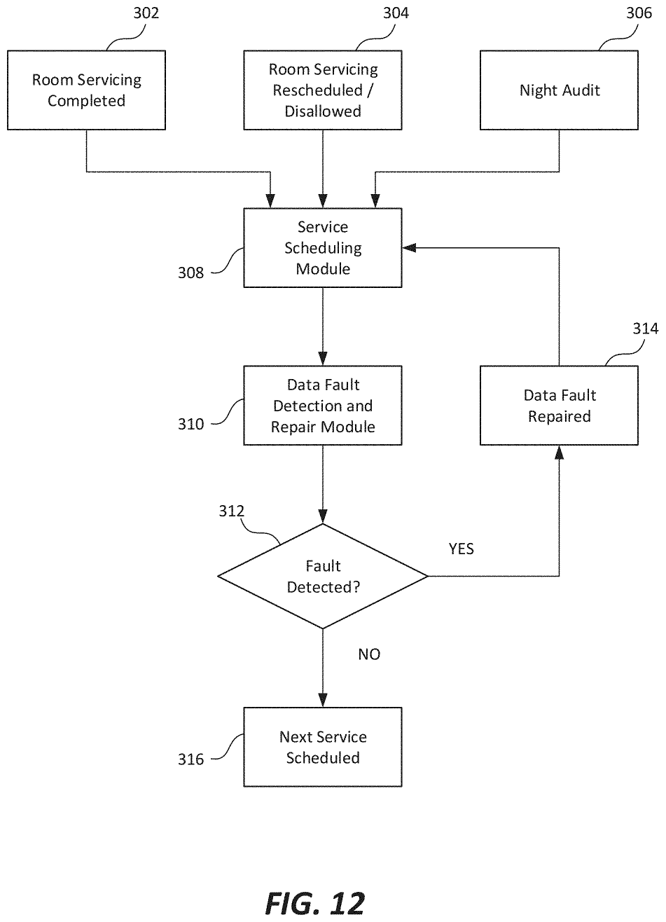

Turning now to FIGS. 11 and 12, FIG. 11 is a functional block diagram illustrating the scheduling module 140 receiving certain key data that must be present and accurate. In this illustration, the “X” indicated associated with the start date 128 is provided to indicate that the system either does not receive readable data, or the data becomes corrupted or the like. The system is provided with fault-tolerance capabilities enabled by fault detection and “best-attempt” recovery efforts from data errors that would prevent the scheduling module 140 from being able to schedule next service dates and types.

Fault tolerance capabilities are provided via a fault detection and repair module 170, which employs mission-critical data-error detection, such as missing a room's “base date” value or “service policy id”, along with data-driven decision heuristics used repair detected data-errors, such as determining what the “best guess” value would be to replace the aforementioned missing “base date” with.

There are five data elements referenced and managed by the service policy feature modules including:

1. Service base: The “reference” date or start date from which intervals are computed, if the “service interval” is a specified number of days. During guest check-in to a room, the initial value for service base or start date is typically set to the check-in date. The start date will either then retain that initial value for the duration of the stay, or have the value adjusted based on service change requests made by the guest (e.g. no service, change of service policy request, etc.)

2. Service policy ID: This is the service policy in effect for a room. This is typically set to the default value for the hotel, but each room can have its own “default” value based on specific servicing requirements of the room.

3. Current service type ID: This is the service type to be completed in the current service cycle (the current service order), typically housekeeping being completed on the given calendar date.

4. Next service: This is the date for the next service cycle or next service order.

5. Next service type ID: This is the service type to be completed during the next service cycle or the next service order stipulated by the next service date.

If the next service or the next service type ID are missing, the scheduling module 140 would be unable to set the required service type when the actual date arrived, and if the service base or the service policy ID were missing, the scheduling module 140 would be unable to compute the next service order (e.g., not know the next service date and type) once the current service order was completed.

FIG. 12 is a functional flow diagram where it is seen that room service completion 302, room service rescheduling/disallowance 304, or the night audit 306 call the service-scheduling module 308, which in turn calls the “fault-detection-and-repair” module 310 to check on the integrity of the five data elements enumerated above 312. It will be understood by those of skill in the art that a night audit is used to update room occupancy information and set other appropriate room information for the next business day. Property Management Systems (PMS) that may integrate with the current system can indicate via an API call to request the system perform data updates and resets for each room commensurate with the night audit. Should the error-detection module detect anomalous or missing values, it will attempt to replace or recover 314 based on the following heuristics for each element and generate the next service schedule 316.

Service base: If there is a missing or corrupted service base or start date, this will be replaced with either the current date or the previous days date, depending on whether the room is respectively a check in or a stay over.

Service policy ID: If there is a missing or corrupted service policy ID value, this will be replaced with either the hotel-wide default value, or the room-specific default value if one is present.

Current service type ID: If there is a missing or corrupted service type ID, this will be replaced by the computing what the likely service type would have been by “reversing” the current date one day to determine what service should have been required today.

Next service/Next service type ID: If there is a missing or corrupted next service date and type, it will be replaced by first checking to see if a service was scheduled, allowed (i.e. not set to no service by guest), and completed for the current date, then computing the next service. If the service was not allowed/not completed and if the current service type allows “slip”, then the service will be set to the next day.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A method for automatically controlling services provided for a facility with a computer coupled to a plurality of mobile devices, the method comprising the steps of:
setting a service policy for a space in the facility, the service policy comprising a plurality of services to be performed for the space according to a time schedule and saving the selected service policy on the computer;
providing a start date for the service policy and saving the start date on the computer;
the computer generating a first service order indicating a first service to be performed in the space at a first indicated time, based on the service policy;
the computer transmitting the first service order to the plurality of mobile devices;
the computer receiving a first indication from one of the plurality of mobile devices to the computer that the first service order has been completed;
the computer generating a second service order indicating a second service to be performed in the space at a second indicated time, based on the service policy;
wherein the first indicated time is different than the second indicated time;
the computer transmitting the second service order to the plurality of mobile devices; and
the computer receiving a second indication from one of the plurality of mobile devices to the computer that the second service order has been completed.

2. The method of claim 1 further comprising the steps of:
the computer receiving a change indication that the first service order is not to be performed;
the computer generating a first change service order indicating the first service to be performed in the space at a third indicated time;
wherein the third indicated time is different than the first indicated time.

3. The method of claim 2 further comprising the steps of:
the computer receiving a first change indication from one of the plurality of mobile devices that the first change service order has been completed;
the computer automatically discarding the second service order and generating a second change service order indicating the second service to be performed in the space at a fourth indicated time;
wherein the fourth indicated time is different than the second indicated time.

4. The method of claim 1 further comprising the steps of:
the computer receiving a change indication that the first service order is not to be performed;
the computer generating a first change service order indicating a third service is to be performed in the space at the first indicated time;
wherein the third service is different than the first service.

5. The method of claim 1 further comprising the steps of:
the computer generating a third service order indicating the first type of service to be performed in the space at a third indicated time;
the computer transmitting the third service order to the plurality of mobile devices; and
the computer receiving an indication from one of the plurality of mobile devices that the third service order has been completed

6. The method of claim 1 wherein if the start date is not available to the computer, the computer automatically selects a replacement start date selected from the group consisting of: the current date or the date of the previous day.

7. The method of claim 1 wherein the start date for the service policy corresponds to is selected from the group consisting of: a day of the week or a date.

8. The method of claim 1 wherein the first service order is provided as a first graphical representation on a display of each of the plurality of mobile devices, and the second service order is provided as a second graphical representation on the display of each of the plurality of mobile devices.

9. The method of claim 8 wherein:
the first service is different than the second service; and
the first graphical representation is different than the second graphical representation.

10. The method of claim 1 wherein the facility comprises a plurality of spaces and the method further comprising the steps of:
setting a first space service policy for the first space in the facility, the first space service policy comprising a plurality of services to be performed for the first space according to a time schedule and saving the selected first space service policy on the computer; and
setting a second space service policy for a second space in the facility, the second space service policy comprising a plurality of services to be performed for the second space according to a time schedule and saving the selected second space service policy on the computer;
wherein the first space service policy is different than the second space service policy.

11. The method of claim 1 wherein the facility comprises a hotel and the space comprises a hotel room within the hotel.

12. The method of claim 11 wherein the first and second services comprise first and second cleaning levels to be applied to the hotel room.

13. The method of claim 1 wherein the first indicated time is calculated as either a day-count-interval format or as a day-of-week format.

14. The method of claim 1 further comprising the step of providing a plurality of service policies;
wherein the step of setting the service policy comprises selecting one of the plurality of service polices.

15. The method of claim 1 further comprising the steps of:
the computer receiving a change indication from a user device that the first service order is not to be performed;
the computer generating a first change service order indicating the service to be performed in the space at a third indicated time;
wherein the third indicated time is different than the first indicated time.

16. The method of claim 15 wherein the user device presents at least one selectable icon relating to the first service order wherein selection of the at least one icon is connected to the change indication.

17. The method of claim 1 further comprising the steps of:
the computer receiving a location of each respective mobile device of the plurality of mobile devices;
the computer correlating the location of each respective mobile device to the various service orders;
the computer transmitting data to the plurality of mobile devices such that various service orders that are associated with various rooms within a geographic limit of a mobile device are indicated on that mobile device.

18. The method of claim 1 further comprising the steps of:
the computer receiving a location of each respective mobile device of the plurality of mobile devices;
the computer correlating the location of each respective mobile device to the various service orders;
the computer receiving data relating to a particular service order setting that particular service order as a priority;
the computer transmitting data to one of the plurality of mobile devices that is identified as being within a geographic limit of a room associated with the priority service order.

19. The method of claim 19 further comprising the step of:
the computer requesting a confirmation from the one of the plurality of mobile devices to which the priority service order data was transmitted that the priority service order can be performed within a threshold time period.

20. A system for automatically controlling services provided for a room in a facility comprising:
a computer including:
a storage having at least one service policy saved thereon, the service policy comprising a plurality of services to be performed for the space according to a time schedule;
an input module configured to receive a start date for the service policy, the start date saved on the storage;
a scheduling module configured to generate service orders based on the service policy and the start date;
said scheduling module configured to generate a first service order indicating a first service to be performed in the space at a first indicated time, based on the service policy;
a plurality of mobile devices configured to receive the first service order;
wherein a first indication is transmitted from one of the plurality of mobile devices to said computer indicating completion of the first service order;
said scheduling module configured to generate a second service order indicating a second service to be performed in the space at a second indicated time, based on the service policy;
wherein the first indicated time is different than the second indicated time; and
wherein a second indication is transmitted from one of the plurality of mobile devices to said computer indicating completion of the second service order.

21. The system of claim 20 wherein the first type of service is different from the second type of service.

22. The system of claim 20 wherein:
a change indication is received by said computer indicating that the first service order is not to be performed; and
said scheduling module is configured to generate a first change service order indicating the first service to be performed in the space at a third indicated time;
wherein the third indicated time is different than the first indicated time.

23. The system of claim 20 wherein:
a change indication is received by said computer indicating that the first service order is not to be performed; and
said scheduling module is configured to generate a first change service order indicating the third service to be performed in the space at the first indicated time;
wherein the third service is different than the first type of service.

24. The system of claim 20 wherein if the start date is not available to the computer, the computer automatically selects a replacement start date selected from the group consisting of: the current date or the date of the previous day.

25. The system of claim 20 wherein the start date for the service policy selected from the group consisting of: a day of the week or a date.

26. The system of claim 20 wherein:
the first service order is provided as a first graphical representation on a display of each of the plurality of mobile devices;
the first service is different than the second service; and
the second service order is provided as a second graphical representation on the display of each of the plurality of mobile devices where the first graphical representation is different than the second graphical representation.

27. The system of claim 20 wherein the facility comprises a hotel and the space is a hotel room within the hotel.

28. The system of claim 20 wherein the first indicated time is calculated as either a day-count-interval format or as a day-of-week format.

29. The system of claim 20 further comprising:
a remote computer coupled to said computer via a network connection.

30. The system of claim 20 wherein said storage has a plurality of service policies saved thereon and wherein one of the plurality of service policies is selected as an active service policy for the room.

31. A system for automatically controlling services provided for a room in a facility comprising:
a computer including:
a storage having at least one service policy saved thereon, the service policy comprising a plurality of services to be performed for the space according to a time schedule;
an input module configured to receive a start date and a duration for the service policy, the start date and duration saved on the storage;
a scheduling module configured to generate service orders based on the service policy and the start date;
said scheduling module configured to generate a first service order indicating a first type of service to be performed in the space at a first indicated time, based on the service policy;
a plurality of mobile devices configured to receive the first service order;
a first graphical representation presented on a display of each of the plurality of mobile devices said first graphical representation corresponding to the first service order;
said scheduling module configured to generate a second service order indicating a second type of service to be performed in the space at a second indicated time, based on the service policy;
a second graphical representation presented on a display of each of the plurality of mobile devices said second graphical representation corresponding to the second service order;
wherein the first service is different from the second service, and the first indicated time is different than the second indicated time; and
wherein the first graphical representation is different than the second graphical representation.

32. The system of claim 31 wherein:
the computer is configured to receive a change indication indicating that the first service order is not to be performed; and
said scheduling module is configured to generate a first change service order indicating the first service to be performed in the space at a third indicated time; and
a first change graphical representation is presented on a display of each of the plurality of mobile devices said first change graphical representation corresponding to the first change service order;
wherein the third indicated time is different than the first indicated time.

33. The system of claim 31 wherein:
the computer is configured to receive a change indication indicating that the first service order is not to be performed; said scheduling module is configured to generate a first change service order indicating the third service to be performed in the space at the first indicated time; and
a first change graphical representation is presented on a display of each of the plurality of mobile devices said first change graphical representation corresponding to the first change service order;
wherein the third type of service is different than the first type of service and the first graphical representation is different than the first change graphical representation.
